(19) United States
(12) Patent Application Publication
(10) Pub. No.: US 2026/0009634 A1
(43) Pub. Date: Jan. 8, 2026

(54) DEVICE, APPARATUS, AND METHOD FOR CONFOCAL-CHROMATIC DISTANCE AND/OR THICKNESS MEASUREMENT

(71) Applicant: MICRO-EPSILON Optronic GmbH, Langebrueck (DE)

(72) Inventors: Tobias Otto, Dresden (DE); Christoph Grueber, Dresden (DE)

(21) Appl. No.: 18/993,368

(22) PCT Filed: May 11, 2023
(86) PCT No.: PCT/DE2023/200093

§ 371 Date: Jan. 10, 2025

(30) Foreign Application Priority Data
Jul. 11, 2022 (DE) 10 2022 207 032.1

(51) Int. Cl. G01B 11/06; G01B 11/02; G01B 11/24; G02B 27/09

(52) U.S. Cl. CPC G01B 11/06; G01B 11/026; G01B 11/24; G02B 27/0988; G01B 2210/50

(57) ABSTRACT

A device for confocal-chromatic, preferably one-dimensional, distance and/or thickness comprises measurement an illumination diaphragm, a confocal-chromatic optical system, and an optical device arranged between the illumination diaphragm and the confocal-chromatic optical system. The optical device splits measuring light emerging from the illumination diaphragm into a plurality of partial beams of measuring light. After passing through the confocal-chromatic optical system, the partial beams of measuring light strike the object to be measured at laterally offset measuring points. The partial beams of measuring light reflected from the measuring points fall onto a receiving diaphragm via the confocal-chromatic optical system and the optical device. After passing through the receiving diaphragm, the partial beams of measuring light result in a common beam of detection light. The disclosure also relates to an apparatus and to a method for confocal-chromatic, preferably one-dimensional, distance and/or thickness measurement.

### BACKGROUND

### Technical Field

The present disclosure relates to a device for confocal-chromatic, preferably one-dimensional, distance and/or thickness measurement, with an illumination diaphragm, a receiving diaphragm, and a confocal-chromatic optical system. Furthermore, the disclosure relates to a relates to an apparatus and method for confocal-chromatic, preferably one-dimensional, distance and/or thickness measurement.

### Description of the Related Art

A confocal-chromatic measuring method is preferentially used due to the advantages of the good spatial separability of the measuring head and the usually combined transmission/receiving/evaluation unit, often in potentially explosive areas, wet areas, high-vacuum environments, or areas with limited space. The basic structure of a conventional confocal-chromatic measuring head has an illumination diaphragm and a confocal-chromatic optical system. Due to the dispersion of the confocal-chromatic optical system, the different wavelengths of the measuring light have different focal points. Here the optical axis of the confocal-chromatic optical system is collinear with the measuring axis on which the focus point group lies. The detection light reflected by the object being measured is detected via the same confocal-chromatic optical system onto a receiving aperture acting as a confocal diaphragm and the dominant wavelength of the reflected detection light is determined using a spectrometer. Taking into account the focal lengths of the individual wavelengths, the distance to the object being measured can be determined from the dominant wavelength.

However, there is the problem that with rough surfaces and primarily diffusely scattering materials, numerous measurement uncertainties occur, which are reflected in a disturbing, location-dependent “noise.”

### BRIEF SUMMARY AND GENERAL DESCRIPTION

The present disclosure is directed to a device and an apparatus for confocal-chromatic distance and/or thickness measurement in such a way that an improved measurement is possible using structurally simple means. Furthermore, an improved method for confocal-chromatic distance and/or thickness measurement is specified.

According to the disclosure, a device is provided for confocal-chromatic, preferably one-dimensional, distance and/or thickness measurement, with an illumination diaphragm and a confocal-chromatic optical system, wherein an optical device is arranged between the illumination diaphragm and the confocal-chromatic optical system, wherein the optical device divides measuring light emerging from the illumination diaphragm into multiple partial beams of measuring light, wherein the partial beams of measuring light strike the object to be measured at laterally offset measuring points after passing through the confocal-chromatic optical system, wherein partial beams of detection light reflected from the measuring points fall onto a receiving diaphragm via the confocal-chromatic optic and the optical device, and wherein after they pass through the receiving diaphragm they result in a common beam of detection light.

An apparatus is provided for confocal-chromatic, preferably one-dimensional, distance and/or thickness measurement, with a device as described herein, in cases with a polychromatic light source for emitting measuring light, a spectrometer, and an evaluation device. The detector can have one detector row. Furthermore, a coupling point can be used to separate the outgoing and return path for the other assemblies.

A method is provided for confocal-chromatic, preferably one-dimensional, distance and/or thickness measurement, in particular with a device as described herein or with an apparatus as described herein. In some cases, a measuring light from a polychromatic light source is guided via an illumination diaphragm to an optical device, wherein the measuring light is divided by the optical device into multiple partial beams of measuring light and guided to a confocal-chromatic optical system, wherein the partial beams of measuring light emerging from the confocal-chromatic optical system strike the measurement object at laterally offset measuring points, wherein partial beams of detection light reflected from the measuring points fall via the confocal-chromatic optical system and the optical device onto a receiving diaphragm, wherein after passing through the receiving diaphragm a common detection light beam is fed to a spectrometer, and wherein a summed, spectrally coded measuring signal of the measuring points is generated.

In accordance with the present disclosure, it has been recognized that if the object being measured is confocal-chromatically measured at multiple measuring points at the same time, local measured value interferences are reduced by means of optical average value formation. In particular, the evaluation of only one summed measurement signal can be carried out on a single detector or spectrometer. Furthermore, the arrangement of a single confocal-chromatic optical system is sufficient.

In a further manner according to the present disclosure, the distances between multiple measuring points within a small region are averaged optically in an absolutely synchronous manner, wherein the detection range can lie within an area with a diameter of, for example, a few tenths to a few hundredths of a millimeter. A further advantage of the disclosure is that the inventive features can be easily integrated into an existing confocal-chromatic measuring system, as there are no or only slight influences on the system design. The light source can advantageously be a white light source.

By means of the teaching according to the present disclosure, instead of the usual one chromatically continuously tuned group of focus points, a plurality of separate groups of focus points corresponding to the number of partial measuring light beams is generated. Due to this special optical arrangement, the chromatically coded measurement reflections of the individual measuring beams are all projected onto the receiving diaphragm via the corresponding optical path. The illumination diaphragm and the receiving diaphragm can be formed by a single or common component. Alternatively, it is conceivable that the receiving diaphragm and the illumination diaphragm are different components. In such a configuration, the receiving diaphragm and the illumination diaphragm are virtually located at least substantially at the same optical location. Furthermore, it is essential that the receiving diaphragm can serve as a confocal diaphragm (spatial filter), i.e., the receiving diaphragm is located in the front focal point of the confocal-chromatic optical system and suppresses wavelengths whose wavelength-dependent focus is in front of or behind the object being measured.

If the individual measuring points have a similar backscattering behavior, which is assumed given the small lateral measuring point distances mentioned above, the superposition of the individual reflections leads to a summed, spectrally encoded intensity signal. If the intensities are approximately the same with similar backscattering behavior, one can speak here of an almost arithmetic averaging. At measuring points with locally different reflection properties, for example at hard edges or material transitions that are smaller than the lateral measuring point distances, the averaging is provided with different weighting components depending on the intensity, whereby the measuring point with the best reflection behavior is emphasized in the optical averaging.

A high signal-to-noise ratio (SNR) is crucial for the reproducibility and stability of a distance measurement. In relation to the teaching according to the present disclosure, this means that the shape and direction of the light beam reflected from the object being measured in combination with the numerical aperture of the lens decisively influences the SNR. This is especially true for rough surfaces with strong local height differences and/or steep profile flanks. Since the reflection component that can be received by the confocal-chromatic optical system decreases with increasing angle between the measuring axis and the surface normal of the illuminated region of the object being measured, the signal-to-noise ratio is subject to strong fluctuations in such a profile measurement. If the SNR falls below a specified limit, this measurement point becomes invalid. This signal noise and also the signal dropouts can be significantly improved with the present disclosure, since measurements are taken at multiple closely spaced measuring points or measuring locations at the same time.

Advantageously, the individual signals can be optically summed so that the signals from the measuring points with a good SNR make the strongest contribution, so that they compensate for the signals with an otherwise poor SNR or even a missing back reflection. This means that the probability of at least one good back reflection is many times higher and thus the failure rate for surfaces with unsuitable reflection properties is correspondingly lower. Due to the optical averaging, invalid measured values are only taken into account in terms of their contribution to the background noise of the summed measurement signal. This gives the averaging a weighting that corresponds to the intensity of the back reflection of a measuring location. However, the advantage of a fail-safe signal is accompanied by an uncertainty in the lateral location assignment, since it is not possible to determine which of the closely spaced measuring points is signal-dominant.

Another advantage of optical averaging is synchronicity. This avoids reduced clock rates in blockwise mathematical averaging or a time delay in the case of moving averaging. Since only one averaged intensity profile from multiple measuring spots is available on the receiver, a better row utilization of the detector is possible. Furthermore, only one assignment table or only one assignment function of distance and wavelength is required.

Furthermore, a large number of objects being measured have a microstructure with peak and valley widths that are larger than the usual measuring spot diameters of confocal-chromatic sensors. This results in topographical signal noise, which in many cases is unwanted by the user of the measuring technology. The teaching according to the present disclosure enables a synchronous optical multi-point measurement so that these extreme peaks and valleys on the surface of the measured object are equalized, resulting in a signal with better SNR. In other words, it is possible to adapt the design to an applicative microstructure, i.e., the number and distance of the individual measuring points can be ideally adapted to a microstructure to be measured in order to obtain the optimal averaging

Furthermore, the measurement of microstructural edges—for example of polished surfaces—on predominantly directly reflective materials is highly error-prone, as only a small amount of light falls into the aperture of the measuring lens due to the reflection angle being too steep, which causes the signal-to-noise ratio to come out correspondingly low. By averaging over multiple measuring points, there is a high probability that the “lost” measurement value of such an edge will be compensated by the simultaneous measurement values of well-aligned plateaus in the neighboring region.

Because the optical device can be used to generate a virtual multi-point diaphragm from the single-point diaphragm of the measuring light, it is easily possible to connect the fiber connection to conventional confocal-chromatic lenses using an adapter. Since all the partial signals are optically superimposed, only one measurement peak is displayed on the spectrometer. In the case of a measurement on a correspondingly large step, the partial signals will form a broadened signal and thus the step will be metrologically smoothed due to the averaging. However, if the step is so large that it leads to the formation of two distinguishable peaks in the spectrogram, a synchronous differential measurement is even possible. Instead of a step, the thickness of a transparent object being measured can also be determined here. In other respects, in summary it can be said that embodiments of the disclosure fully meet the condition of compatibility with existing systems. Because embodiments of the disclosure can be paired with conventional lenses and spectrometers, the costs for this flexible feature are also low.

For optical averaging of multiple measuring locations, it is sufficient to add an optical device between the illumination diaphragm and the associated confocal-chromatic optical system. The coupling point for the incoming measuring light and the outgoing chromatically coded detection light can be located in front of the illumination diaphragm. The illumination diaphragm and/or the receiving diaphragm can be realized, for example, by an optical diaphragm element. Such a design is advantageous if the coupling point is realized by a beam splitter or beam splitter cube. It is also conceivable for the illumination diaphragm and/or the receiving diaphragm to be formed by a fiber end of a optical waveguide. This is advantageous if a optical waveguide is used between the coupling point and the confocal chromatic optical system, so that its fiber end forms the illumination diaphragm or the receiving diaphragm.

The optical device, which can have one or more optical elements, splits the measuring light emerging from the illumination diaphragm into multiple partial beams of measuring light. The measuring light partial beams could be directed as diverging measuring light partial beams onto the confocal-chromatic optical system. According to a further advantageous embodiment, the measuring light partial beams can be individually focused on a virtual surface located in front of the confocal-chromatic optical system. The virtual surface can advantageously coincide with the focal point or the focal plane of the confocal-chromatic lens.

Advantageously, the optical device can have at least one optical element, in particular a refractive optical element and/or a diffractive optical element (DOE) and/or a meta-optical element (MOE). Specifically, the optical element could be a roof prism and/or a microlens array and/or an optical pyramid, preferably a regular pyramid or a right square pyramid. In a configuration of the optical device that generates a partial beam of measuring light without intermediate foci, the measuring light could be divided into multiple partial beams of measuring light by means of a roof prism or a right regular pyramid, preferably a right square pyramid. These partial beams of measuring light then pass through the confocal-chromatic optical system and are subjected to the longitudinal chromatic aberration that makes the distance measurement possible in the first place. However, in contrast to the intended use, these measuring light partial beams strike the first lens surface at a different angle of incidence. This ultimately leads to the chromatic focus point groups caused by the confocal-chromatic optical system running outside the measuring axis and thus forming multiple measuring axes. The reason for this is the changed angle of incidence of the measuring light partial beams on the confocal-chromatic optical system caused by the deflection, since the virtual source point of the measuring light partial beams is shifted away from the axis due to the inclined surfaces. Since a larger numerical aperture of the light source is captured by the confocal-chromatic optical system and distributed to the measuring points due to the beam deflection, the sum of the focal areas is larger than that of the confocal-chromatic optical system when used for a single measuring point. As a result, the confocal-chromatic optical system in combination with the optical element may be slightly faster than the original lens if the original lens does not use the maximum aperture of the confocal diaphragm.

In a further advantageous manner, the optical element can be supplemented with a second optical element, for example a converging lens or a diverging lens. It is conceivable and advantageous that the second optical element is formed in one piece with the optical element or is arranged materially bonded on the optical element or is printed on the optical element. Alternatively, it is conceivable that the second optical element is integrated into an optical surface of the optical element. For example, an optical surface of the optical element facing the light source can be flat and an optical surface facing away from the light source can fulfill the function of the optical element and of the second optical element in the sense of a complex free-form surface. These design measures make it possible to adjust the captured numerical aperture of the illumination diaphragm as well as the lateral position and measuring spot shape.

According to an advantageous embodiment, the divergent light of the entrance diaphragm can initially be almost collimated by the optical device, in particular by a first optical surface of an optical element. Furthermore, it is conceivable that by means of a microlens array, i.e., multiple closely spaced microlenses, the collimated overall aperture is almost completely divided into multiple subapertures and each is refocused onto a common virtual surface. Depending on the design of the confocal chromatic optical system and the measuring surface, this focal surface may also be curved. Such an arrangement can be understood as the division of a primary light source into multiple secondary light sources, this being the image of the receiving diaphragm. Thus, the size of the secondary light area and the aperture of the secondary light depend on the beam shaping of the optical element. The advantage of such a division of a primary light source into multiple secondary light sources with the proposed design is that the extension remains in a system without necessary feedback effects in the direction of the light source, since the radiant power of the primary light source is divided among the secondary light sources with almost no loss. To improve the distance resolution of a measuring system, in addition to an increase in the signal-to-noise ratio, the narrowing of the measurement peak width in the spectrogram is also very effective. When the aperture of the primary light source is divided into subapertures and their separate focusing on an area of virtual secondary light sources, as described above, the virtual secondary light sources have a smaller extension or spot size compared to the primary light source.

In order to avoid intensity drops in the edge region when illuminating the confocal-chromatic optical system, the optical design can be such that only part of the theoretically available aperture of the illumination beam is utilized. Since multiple secondary light sources are formed from the primary light source when using a microlens array in the optical device, various parameters can be changed. For example, it is possible to use a higher proportion of the numerical aperture of the primary light source, which, when using the same confocal-chromatic optical system, would make it faster overall. Alternatively, the numerical apertures of the measuring light beams can be varied from the numerical aperture provided for the confocal-chromatic optical system. This ultimately allows the target parameters of the measuring points to be varied, which gives the optical device additional flexibility in adapting to the measuring task.

Due to the skilled arrangement of microlenses over the entire surface of the fiber aperture, it is possible to direct almost the entire luminous flux of the measuring light to the object being measured. Although the individual intensities of the many measuring spots each have only a corresponding fraction of the intensity of a conventional device, the overall signal after recombination of the individual channels has a similarly high signal strength as with a conventional device or a conventional measuring head.

In a particularly advantageous manner, the lateral distance of the measuring spot axes can be varied by minor changes to this optical element, which is otherwise independent of the measuring lens, which can be particularly advantageous due to the emergence of additive lens manufacturing.

Since the mutual crosstalk of the individual measurement channels leads to a broadening of the summed measurement signal peak, it is advantageous to increase the lateral resolution (x-direction) as well as the depth resolution (z-direction). For this purpose, it is advantageous to use an occluding of the central region of a focused beam. This takes advantage of the fact that in the focus the depth of field of the edge beams is significantly smaller than the depth of field of the beams near the axis, due to an obtuse angle of incidence. By occluding these near-axis beams, a significantly shorter depth of field is achieved at the cost of a lower light intensity. The smaller the depth of field, the higher the achievable selectivity in the focus point group, which is reflected by a significantly slimmer peak in the spectrogram. In an advantageous manner, the optical device can thus be used to occlude near-axis measuring light partial beams of the measuring light partial beam bundle. The center occluding of the measuring light partial beams could be achieved by masking the optical device or one or more optical elements of the optical device at the decisive points with a non-transparent layer, for example with chromium or a lacquer. Such a design is particularly advantageous if a microlens array is provided in the optical device.

Furthermore, it is conceivable to deflect the near-axis measuring light partial beams into the edge zones of the confocal-chromatic optical system or outside of them, so that these beams are suppressed for imaging according to the principle of a beam trap. This also creates a center occluding. For this purpose, a focusing lens of the optical device can have a beam-deflecting surface in the core zone near the axis, or can be interrupted by this surface. This may require a complex surface structure that differs from the classical optical system. Alternatively, this partial beam deflection can also be achieved through the special design options of diffractive optical elements (DOE) or meta-optical elements (MOE). Also, an annular lens or only segments of an annular lens could be provided in the optical device for producing a central occluding.

In a particularly advantageous manner, the optical device can have an optical element with multiple lens fragments, wherein central lens fragments located in a central region and peripheral lens fragments located in an edge region are arranged and wherein the central lens fragments each deflect the measuring light striking them in such a way that it is superimposed with the measuring light deflected by an edge lens fragment and forms a common measuring light partial beam. This has the advantage that, in contrast to a center occluding, a large amount of light can be used from the occluded or deflected center zone. In other words, a skilled interlacing or interpenetration of lens fragments can be realized in order to use the light from the unused lens zones for imaging in neighboring regions. The outlines of the interlaced lens fragments can take on regular patterns or also irregular ones. In one design variant, for example, an intensity weighting of the virtual secondary light sources can be achieved by varying the number or size of the segment surfaces associated with a focal point. In principle, the arrangement of the lens fragments is advantageous if the distribution of the light beams, which together form the secondary light sources in the virtual plane, is spatially balanced and follows a symmetry. This counteracts a different tilt characteristic of the individual measuring axes and thus prevents a tilt-dependent intensity weighting and thus a different weighting in the optical averaging on the individual measuring axes with a coherent illumination and imaging beam path.

The described interpenetration of microlens fragments can also be realized with an optical device that generates a divergent measuring light partial beam. Despite the obvious advantages of this variant embodiment, there are also limitations depending on the target parameters, which may make one of the other embodiments more advantageous.

Overall, the virtual occluding of the near-axis central beam offers two advantages. On the one hand, the solid angle offered by the primary light source is not segmented into smaller solid angles by the small microlenses arranged next to each other, but in each case the almost complete solid angle offered is exploited by interleaving the lens fragments of substantially larger, theoretically overlapping lenses. As a result, the numerical aperture of the virtual secondary light sources is insignificantly smaller than that of the primary light source. This is reflected in an already narrow measurement peak in the spectrogram. On the other hand, this interleaving of the fragments of the large lenses leaves out the central zone of each beam. It has been found that the average numerical aperture of a centrally occluded beam is significantly higher than that of an unoccluded beam. This results in a significantly smaller depth of field and thus a higher chromatic selectivity, resulting in a significantly narrower measurement peak. Thus, the interpenetrating microlens array is of great advantage for distance resolution.

Furthermore, it should be noted that the features of the device according to the present disclosure and of the apparatus according to the present disclosure can also be instantiated as a method. A combination of these features with the features relating to the method claim is not only possible, but advantageous. Likewise, the features of the method according to the present disclosure can also have a constructive instantiation. The combination of these features with the features relating to the device claim and/or to the apparatus claim is not only possible, but advantageous.

### BRIEF DESCRIPTION OF THE SEVERAL VIEWS OF THE DRAWINGS

There are various possibilities for designing and developing the teaching of the present disclosure in an advantageous manner. To this end, reference is made, on the one hand, to the claims and, on the other, to the explanation of preferred exemplary embodiments of the disclosure based upon the drawings. Generally preferred embodiments and developments of the teaching are also explained in conjunction with the explanation of the preferred exemplary embodiments of the disclosure with reference to the drawings. In the drawings:

FIG. 1 shows a schematic representation of an exemplary embodiment of an apparatus according to the present disclosure,

FIG. 2 shows a schematic representation of another exemplary embodiment of an apparatus according to the present disclosure,

FIG. 3 shows a schematic representation of a device according to the prior art,

FIG. 4 shows a schematic representation of an exemplary embodiment of a device according to the present disclosure,

FIG. 5 shows a schematic representation of another exemplary embodiment of a device according to the present disclosure,

FIG. 6 shows a schematic representation of another exemplary embodiment of a device according to the present disclosure,

FIG. 7 shows a schematic representation of another exemplary embodiment of a device according to the present disclosure,

FIG. 8 shows a schematic representation of another exemplary embodiment of a device according to the present disclosure,

FIG. 9 shows spectrograms of an apparatus according to the present disclosure, with the wavelength plotted against the intensity,

FIG. 10 shows spectrograms of an apparatus according to the present disclosure, with the wavelength plotted against the intensity,

FIG. 11 shows spectrograms of an apparatus according to the present disclosure, with the wavelength plotted against the intensity,

FIG. 12 shows spectrograms of an apparatus according to the present disclosure, with the wavelength plotted against the intensity,

FIG. 13 shows an exemplary embodiment of an optical device,

FIGS. 14a and 14b each show an exemplary embodiment of an optical device,

FIGS. 15a, 15b, and 15c each show an exemplary embodiment for the arrangement of square lens fragments, and

FIGS. 16a and 16b each show an exemplary embodiment of an optical device.

### DETAILED DESCRIPTION

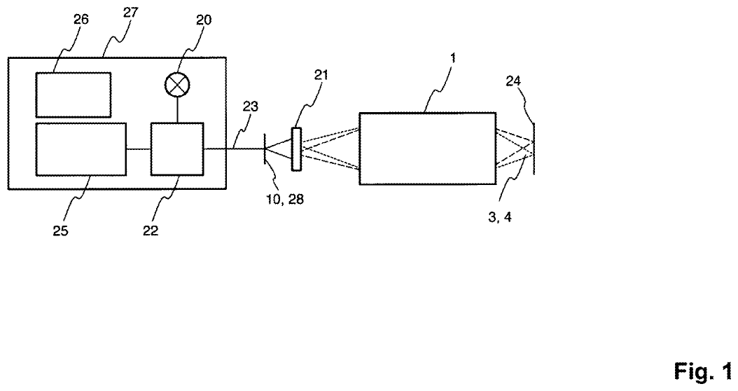

FIG. 1 shows an exemplary embodiment of an apparatus according to the present disclosure. This apparatus has a light source 20 which emits measuring light which is guided by an optical coupling element 22, for example a beam splitter or a beam splitter cube or an optical fiber coupler, to an illumination diaphragm 10, for example an optical diaphragm element. The illumination diaphragm 10 also serves here as a receiving diaphragm 28. In this case, an optical waveguide 23 can also be provided, the free end of which can realize the illumination/receiving diaphragm 10, 28, so that it is not necessary to provide an optical diaphragm element.

Furthermore, an optical device 21 is arranged which divides the measuring light into multiple measuring light partial beams 3, 4 which fall on a confocal-chromatic optical system 1, so that multiple measuring light partial beams 3, 4 fall on the object being measured 24 at different measuring points. The detection light beams reflected by the object being measured 24 are guided through the confocal-chromatic optical system 1, the optical device 21, and the receiving diaphragm 28 and, if applicable, the light guide 23 to the optical coupling element 22 and from there to the spectrometer 25. The spectrometer 25 preferably has only a single measuring row. The signals of the spectrometer 25 are evaluated by an evaluation unit 26. Furthermore, a controller 27 is provided for controlling the individual components.

By way of the confocal-chromatic optical system 1, instead of the usual one chromatically continuously tuned group 7 of focus points, a plurality of separate groups of focus points corresponding to the number of partial measuring light beams 3, 4 is thus generated. The chromatically coded detection light partial beams are all reflected back to the illumination/receiving diaphragm 10, 28 via the corresponding optical path. Due to the small lateral measuring point distances of the measuring light partial beams 3, 4, a similar backscattering behavior of the individual measuring points is assumed and the superposition of the individual reflections leads to a summed, spectrally coded intensity signal, so that a synchronous optical averaging is provided.

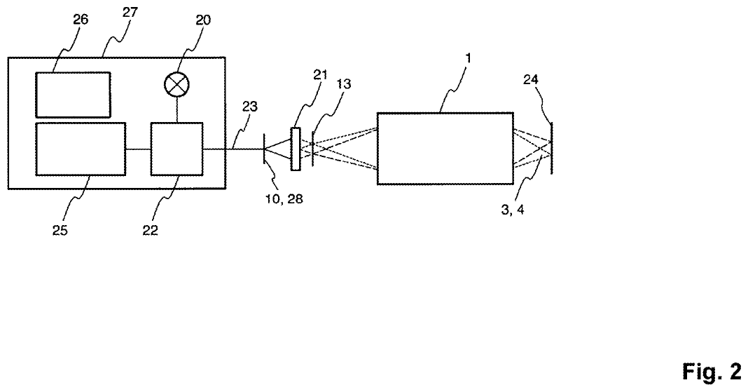

FIG. 2 shows an exemplary embodiment of an apparatus according to the present disclosure. This substantially corresponds to the apparatus according to FIG. 1, so that reference is made to the above description thereof in order to avoid repetition. The essential difference is that the optical device 21 is designed such that the measuring light partial beams are individually focused on a virtual surface 13 located in front of the confocal-chromatic optical system 1.

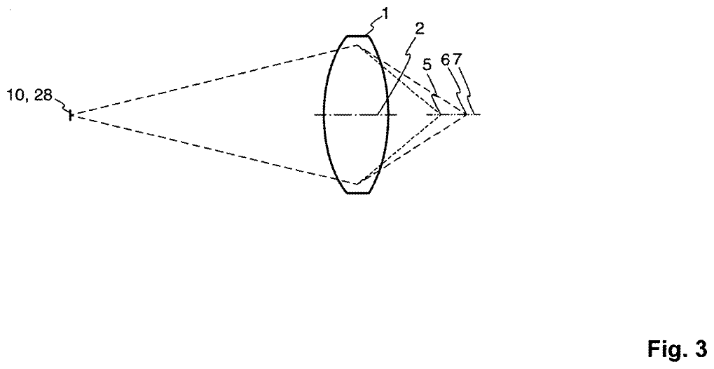

FIG. 3 shows a schematic representation of a device for confocal-chromatic distance and thickness measurement according to the prior art. This device has an illumination/receiving diaphragm 10, 28 and a confocal-chromatic optical system 1. Furthermore, the focus points 5, 6 are shown with different wavelengths. Here the optical axis of the confocal-chromatic optical system 1 is collinear with the measuring axis 7 on which the focus point group lies.

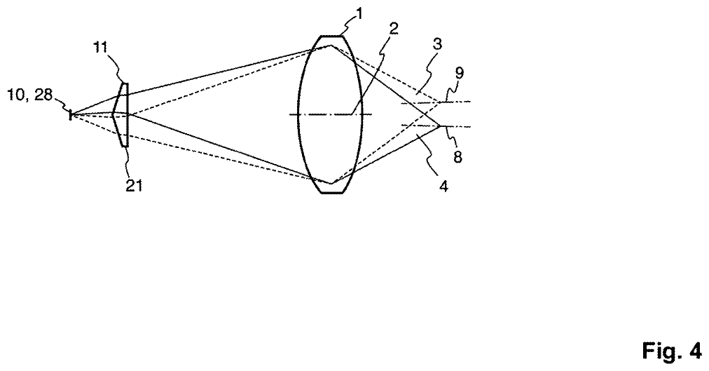

FIG. 4 shows a schematic representation of a further embodiment of a device according to the present disclosure with an illumination/receiving diaphragm 10, 28, an optical device 21 having an optical element 11, and a confocal-chromatic optical system 1. The aperture of the light beam radiating from the illumination diaphragm 10 is divided by the optical element 11 into multiple (here: two) partial beams of measuring light 3, 4 and is separately chromatically aberrated in each case by the confocal-chromatic optical system 1. The resulting groups of focus points on the measuring axes 8, 9 are close to each other.

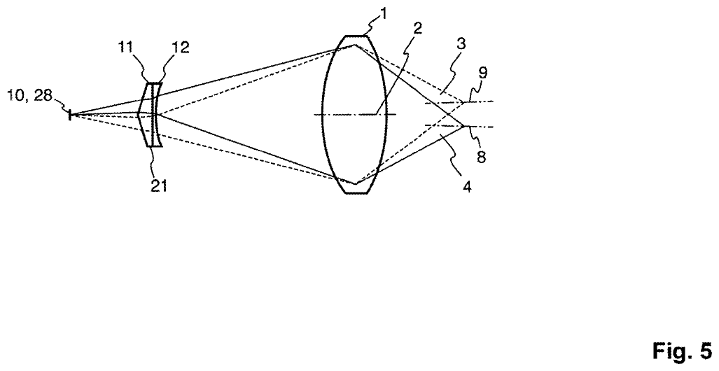

FIG. 5 shows a schematic representation of a further embodiment of a device according to the disclosure with an illumination/receiving diaphragm 10, 28, an optical device 21 and a confocal-chromatic optical system 1. In addition to the optical element 11 according to FIG. 4, the optical device 21 has a further optical element 12 which has a further beam-forming property. This allows-independently of the confocal-chromatic optical system 1—the amount of light and the measuring spot size to be influenced.

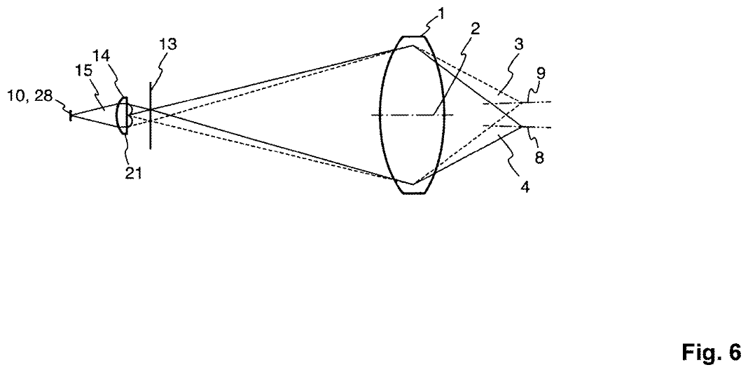

FIG. 6 shows a schematic representation of a further embodiment of a device according to the present disclosure with an illumination/receiving diaphragm 10, 28, an optical device 21, and a confocal-chromatic optical system 1. The measuring light 15 is divided into multiple measuring light partial beams 3 by means of the optical device 21 realized as a microlens array 14 and these are each focused. These focal points are located in a virtual surface 13, the shape of which can be flat or curved due to the individual lenses. This can influence the shape of the measuring surface if appropriate. The focus points act like secondary light sources, each using the same optical system. As a result, the chromatic curves of the individual focus point groups 8, 9 are extremely similar.

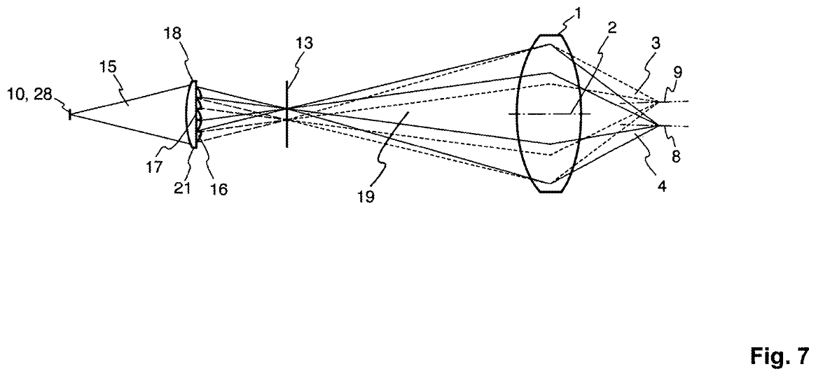

FIG. 7 shows a schematic representation of a further embodiment of a device according to the present disclosure with an illumination/receiving diaphragm 10, 28, an optical device 21 and a confocal-chromatic optical system 1. The optical device 21 has a microlens array 18. The measuring light beam emitted by the light source 10 is split by a microlens array 18 of the optical device 21 into multiple beams, each of which strikes a lens fragment 16. Since the lens fragments 16 each have only the surface curvature of fragments formed from the edge region of a complete lens, it is possible for the central regions to be occupied by adjacent lenses. As a result, the central region of a lens 17 to be suppressed is used for the virtual focus of an adjacent light beam. As a result, the measuring light partial beams 3, 4 focused on the virtual surface 13 are centrally occluded, which can be seen by the dimmed zone 19. It is important that the light from the central region is not discarded, but is used for imaging in neighboring regions, so that the amount of light used from the measuring light is higher than with a conventional central occluding. This is therefore a virtual center occluding, in which the partial beams are occluded in the center, but the sum of the partial beams is not. This improves the depth resolution on the one hand and at the same time significantly reduces crosstalk between the individual channels.

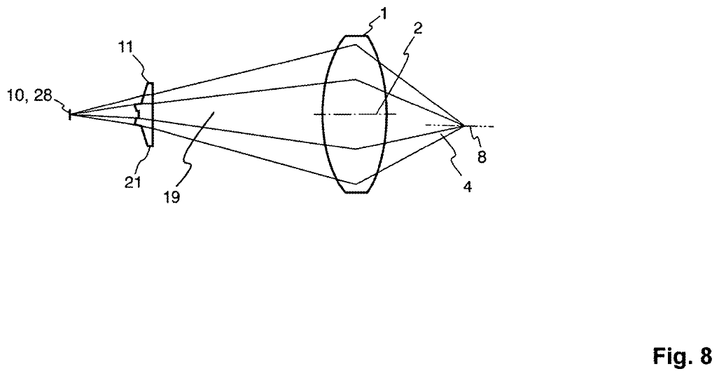

FIG. 8 shows a schematic representation of a further embodiment of a device according to the present disclosure with an illumination/receiving diaphragm 10, 28, an optical device 21 having an optical element 11, and a confocal-chromatic optic 1. According to the embodiment shown in FIG. 4, measuring light is split by the optical element 11 in this example into two measuring light partial beams. In order to diaphragm the middle zone 19 without loss, the two surfaces above and below the optical axis 2 in the central region 19 are each interrupted by an oppositely running element. The central part of the beam is directed into another target field by these opposite optical elements. For the sake of clarity, only the beams belonging to a common measuring axis are shown.

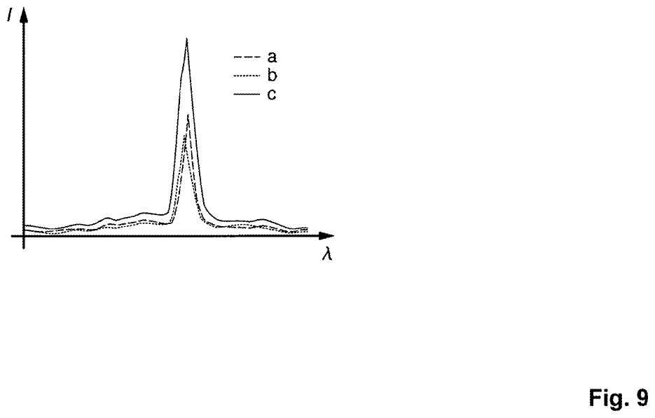

FIG. 9 shows spectrograms of a device according to the present disclosure, wherein the wavelength (2) is plotted against the intensity (I). In optical averaging, two optical signals are combined in one channel, whereby the first signal a together with the second signal b produces a sum spectrogram c. If the center of gravity of this signal is determined, it corresponds to the mean of the individual signal centers, but weighted by the total intensity.

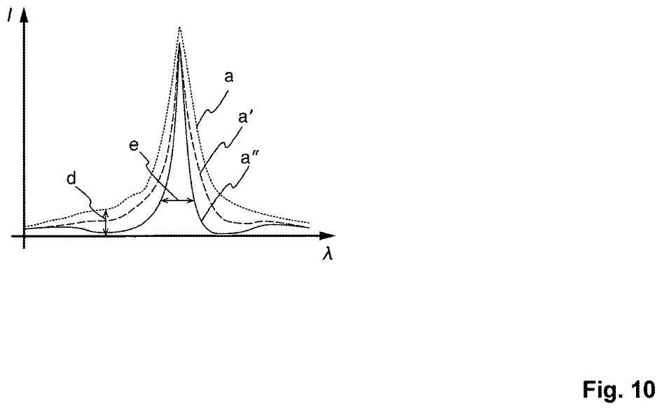

FIG. 10 shows spectrograms of a device according to the present disclosure in a qualitative comparison with plotted signal intensity (I) over the wavelength (2).

The spectrogram a was created using an optical device that has a pyramid structure, wherein a high noise level d and a large peak width e can be seen.

Spectrogram a′ was obtained using an optical device having a microlens array, wherein a reduced noise level d and a smaller peak width e can be seen.

Spectrogram a″ was created using an optical device with interleaved lens segments with virtual center occluding.

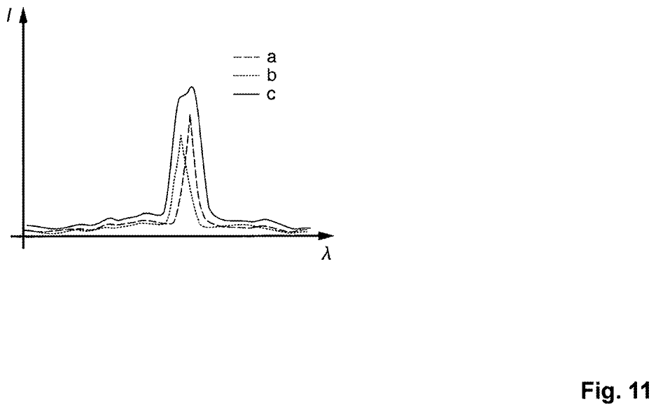

FIG. 11 shows a spectrogram for the measurement on a step. If the step is too small, the optical averaging over multiple measuring locations inevitably leads to a metrological smoothing of the edge. For simplified illustration, the representation is reduced to two measuring axes.

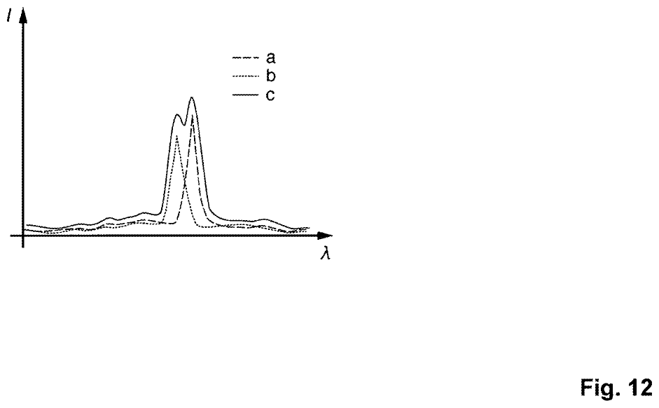

FIG. 12 shows a spectrogram for the measurement on a large step. Due to a sufficient difference in height between the individual distances, there is a distinction in the spectrogram. This even makes it possible to permanently determine the height difference of a step or the thickness of an object.

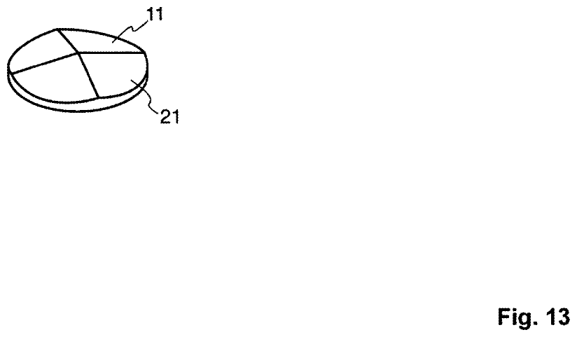

FIG. 13 shows an embodiment of an optical element 11 of an optical device 21. This is realized as a pyramid-shaped optical element 11.

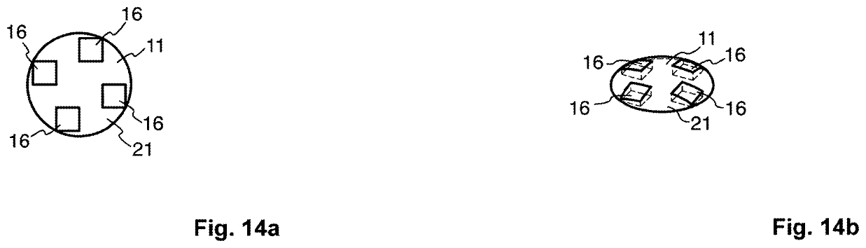

FIGS. 14a and 14b each show an embodiment of an optical element 11 of an optical device 21. FIG. 14a shows, specifically, the fragmentation of a lens with the central region left out, in a plan view. In FIG. 14b, fragments from the edge region of a convex lens can be seen in a trimetric view.

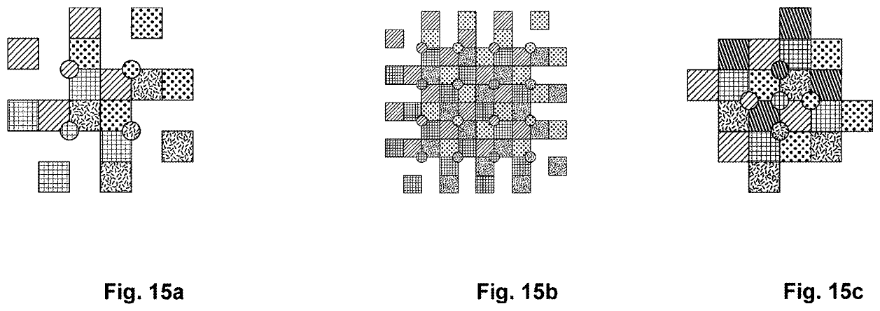

FIGS. 15a, 15b, and 15c each show embodiments for the arrangement of square lens fragments. Four squares represent four lens fragments in each case. The color-coded circular areas, which are located in the center of each such group, indicate the focal point in the depth created by the lenses. The lens fragments can also have a different geometry, for example round or hexagonal.

FIG. 15a shows an example of an arrangement of four interleaved lens fragment groups, which allows infinite interleaving.

FIG. 15b shows a seamless, interleaved arrangement of 16 measuring points, which can be extended infinitely.

FIG. 15c shows a dense interleaving of five lens groups. However, this highly efficient use of a circular aperture cannot be extended without loss.

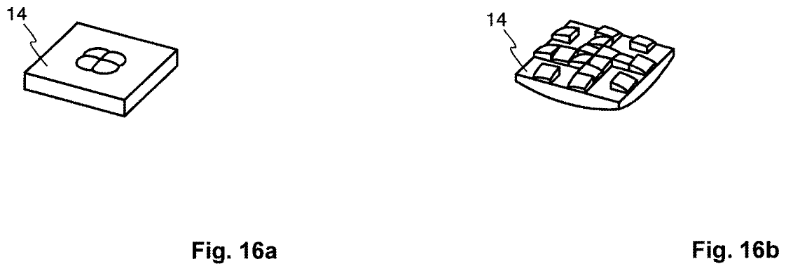

FIGS. 16a and 16b each show an embodiment of an optical device. FIG. 16a relates to a microlens array 16 with complete division of the aperture. FIG. 16b relates to a microlens array 16 with an interpenetrated arrangement of lens fragments.

With regard to other advantageous embodiments of the apparatus according to the present disclosure, reference is made to the general part of the description and also to the accompanying claims in order to avoid repetitions.

Finally, it is expressly pointed out that the above-described exemplary embodiments of the apparatus according to the present disclosure serve only to explain the claimed teaching but do not restrict it to the exemplary embodiments.

### LIST OF REFERENCE SIGNS

1 Confocal-chromatic optical system
2 Optical axis
3 Measuring light partial beam
4 Measuring light partial beam
5 Focal point
6 Focal point
7 Axis of the axial focal point group
8 Axis of an off-center group of measuring points
9 Axis of an off-center group of measuring points
10 Illumination diaphragm
11 Optical element
12 Optical element
13 Virtual surface
14 Microlens array
15 Primary light beam
16 Lens fragment
17 Lens fragment for an adjacent region
18 Microlens array
19 Dimmed zone
20 Light source
21 Optical device
22 Optical coupling element
23 Optical waveguide
24 Measured object
25 Spectrometer
26 Evaluation unit
27 Controller
28 Receiving diaphragm
a Spectrogram
b Spectrogram
c Summed spectrogram
d Noise level
e Peak width

The various embodiments described herein can be combined to provide yet further embodiments. These and other changes can be made to the embodiments in light of the above description. In general, in the following claims, the terms used should not be construed to limit the claims to the specific embodiments disclosed in the specification and the claims, but should be construed to include all possible embodiments along with the full scope of equivalents to which such claims are entitled.

1. A device for confocal-chromatic distance and/or thickness measurement, comprising:
an illumination diaphragm;
a confocal-chromatic optical system and
an optical device is arranged between the illumination diaphragm and the confocal-chromatic optical system,
wherein the optical device is configured to divide measuring light emerging from the illumination diaphragm into multiple partial beams of measuring light,
wherein the partial beams of measuring light strike an object being measured at laterally offset measuring points after passing through the confocal-chromatic optical system,
wherein partial beams of detection light reflected from the measuring points fall onto a receiving diaphragm via the confocal-chromatic optical system and the optical device, and
wherein, after the passing through the receiving diaphragm, a common detection light beam is present.

2. The device according to claim 1, wherein the illumination diaphragm and/or the receiving diaphragm is/are formed by a fiber end of an optical waveguide and/or by at least one optical diaphragm element.

3. The device according to claim 1, wherein the illumination diaphragm and the receiving diaphragm are formed by a common component.

4. The device according to claim 1, wherein the optical device has at least one optical element.

5. The device according to claim 4, wherein the optical element is a roof prism and/or a microlens array and/or an optical pyramid.

6. The device according to claim 4, wherein the optical element is a first optical element supplemented with a second optical element.

7. The device according to claim 6, wherein the second optical element is formed in one piece with the first optical element or is arranged in a materially bonded manner on the first optical element or is printed on the first optical element.

8. The device according to claim 1, wherein the optical device focuses the partial beams of measuring light individually onto a virtual surface located in front of the confocal-chromatic optical system.

9. The device according to claim 8, wherein the virtual surface lies in the focal point of the confocal-chromatic optical system.

10. The device according to claim 1, wherein the optical device is configured to divide the measuring light emerging from the illumination diaphragm into diverging partial beams of measuring light).

11. The device according to claim 1, wherein the optical device diaphragms the partial beams of the measuring light that are close to the axis.

12. The device according to claim 1, wherein near-axis measuring light partial beams of the partial beams of measuring light are deflectable by the optical device such that they do not strike the confocal-chromatic optical system and/or only strike it in an edge region.

13. The device according to claim 1, wherein a focusing lens of the optical device has a beam-deflecting surface in a core zone close to the axis and/or is interrupted by this beam-deflecting surface.

14. The device according to claim 1, wherein the optical device has an optical element with multiple lens fragments, wherein central lens fragments located in a central region and peripheral lens fragments located in an edge region are arranged, and wherein the central lens fragments each deflect the measuring light striking them such that the measuring light is superimposed with the measuring light deflected by an edge lens fragment and forms a common partial beam of measuring light.

15. An apparatus for confocal-chromatic distance and/or thickness measurement, comprising:
a device according to claim 1,
an polychromatic light source for emitting measuring light,
a spectrometer, and
an evaluation device.

16. A method for confocal-chromatic distance and/or thickness measurement, comprising:
guiding measuring light from a polychromatic light source via an illumination diaphragm to an optical device,
dividing the measuring light by the optical device into multiple partial beams of measuring light,
guiding the partial beams of measuring light to a confocal-chromatic optical system, wherein the partial beams of measuring light emerging from the confocal-chromatic optical system strike a measurement object at laterally offset measuring points, and wherein partial beams of detection light reflected from the measuring points fall via the confocal-chromatic optical system and the optical device onto a receiving diaphragm,
after passing the partial beams of measuring light through the receiving diaphragm, feeding a common detection light beam is fed to a spectrometer, and
generating a summed, spectrally coded measuring signal of the measuring points.

17. The device according to claim 4, wherein the optical element is a refractive optical element and/or a diffractive optical element and/or a meta-optical element.

18. The device according to claim 6, wherein the second optical element is integrated in an optical surface of the first optical element.

19. The device according to claim 8, wherein the virtual surface is a curved surface.

20. The device according to claim 11, wherein the optical device diaphragms the partial beams of the measuring light by masking at least one optical element with a non-transparent layer.
